(19) United States
(12) Patent Application Publication
(10) Pub. No.: US 2017/0109696 A1
(43) Pub. Date: Apr. 20, 2017

(54) VEHICLE CAPACITY UTILIZATION FOR PACKAGE DELIVERY

(71) Applicant: DICOM TRANSPORTATION GROUP, Dorval (CA)

(72) Inventors: Kirk Serjeantson, Dorval (CA); Pierre Luc Nicol, Dorval (CA); Antony Voyer, Dorval (CA); Vu Le, Dorval (CA); Doaa Elmasry, Dorval (CA); Matthew Dunlop, Dorval (CA)

(73) Assignee: DICOM TRANSPORTATION GROUP, Dorval (CA)

(21) Appl. No.: 15/298,845

(22) Filed: Oct. 20, 2016

Related U.S. Application Data
(60) Provisional application No. 62/243,776, filed on Oct. 20, 2015.

(51) Int. Cl. G06Q 10/08; G06Q 30/02

(52) U.S. Cl. CPC G06Q 10/08355; G06Q 30/0217

(57) ABSTRACT

A system and method for optimizing vehicle capacity utilization in package delivery is provided. Discounts are generated for potential customers along a delivery route are determined and sent to the customers. If the offer is accepted the vehicle route is modified to enable pickup of the packages.

### CROSS-REFERENCE TO RELATED APPLICATIONS

This applications claims priority from U.S. Provisional Patent Application No. 62/243,776 filed Oct. 20, 2015 the entirety of which is hereby incorporated by reference for all purposes.

### TECHNICAL FIELD

The present disclosure relates to package delivery to vehicle capacity utilization.

### BACKGROUND

In the transportation industry it is important to build density to optimize vehicle usage and provide maximum efficiency. Density is defined by a cluster of pickup or deliveries in a specific geographical region. Density reduces cost by limited the amount of travel time for a driver between the actions of pickup or delivery.

Some courier companies offer discounts in areas based on stem times from terminals. Also, some companies offer discounts in malls or strip malls where business (pickup and deliveries) already exist. This is done manually and no real time technology exists. Existing technologies are reactive and do not provide an efficient method of increasing density of vehicle usage. The present solutions take into account where existing business is present, however the solutions are implemented manually and is not used to target and grow density.

Accordingly, systems and methods that enable more efficient vehicle utilization remains highly desirable.

### BRIEF DESCRIPTION OF THE DRAWINGS

Further features and advantages of the present disclosure will become apparent from the following detailed description, taken in combination with the appended drawings, in which:

FIG. 1 shows a representation of a capacity utilization management system;

FIG. 2 shows a representation of less-than-truckload system; and

FIG. 3 shows a method of vehicle capacity utilization for package delivery.

It will be noted that throughout the appended drawings, like features are identified by like reference numerals.

### DETAILED DESCRIPTION

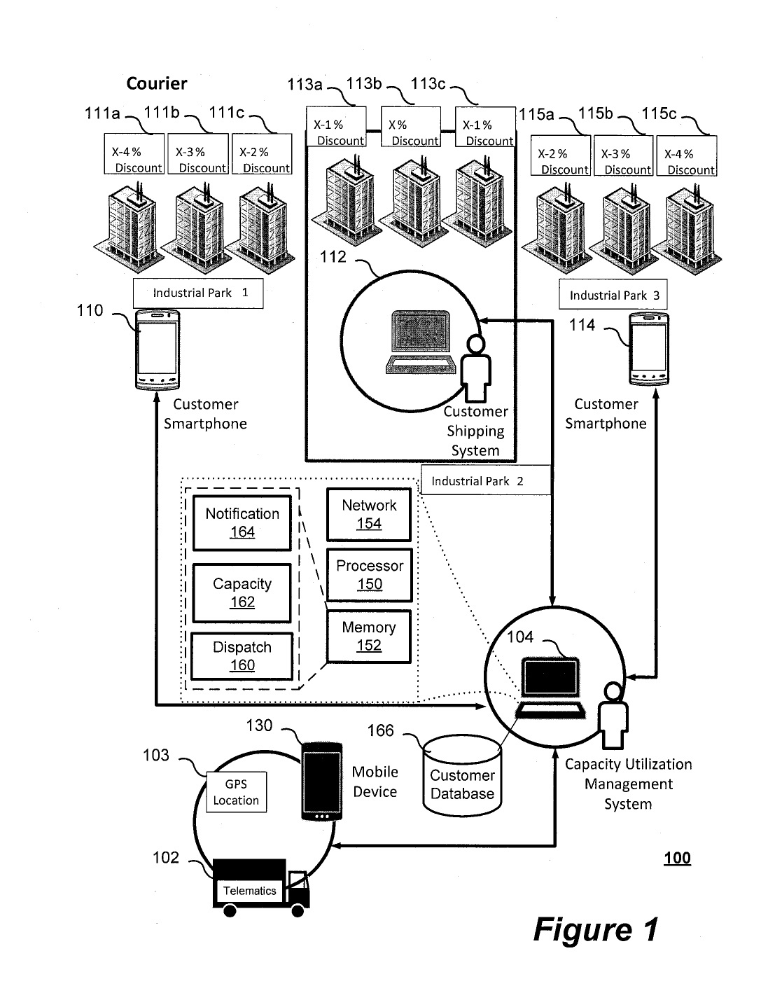

The invention will now be described in detail with reference to various embodiments thereof as illustrated in the accompanying drawings. Specific details are set forth in order to provide a thorough understanding of the invention. It will be apparent to one skilled in the art that the invention may be practiced without using some of the implementation details set forth herein. It should also be understood that well known operations have not been described in detail in order to not unnecessarily obscure the invention. Embodiments are described below, by way of example only, with reference to FIGS. 1-3.

In accordance with an aspect of the present disclosure there is provided determining at a capacity utilization management system a location of the vehicle from global positioning data associated with the delivery vehicle; determining capacity of the vehicle based upon capacity parameters associated with the vehicle, items in the vehicle and expected items to be loaded into the vehicle; determining one or more customers on a planned route of the vehicle that are within a defined proximity radius of one or more stops along the planned route; determining shipping cost discounts for the one or more customers based upon the determined capacity of the vehicle; sending electronic notifications to the possible customers advising of shipping cost discounts available during a time period based upon the planned route of the vehicle; receiving notification of acceptance from a customer for picking up a shipment by the vehicle; and modifying the planned route for the vehicle to a customer location associated with the acceptance notification.

In accordance with yet another aspect there is provided a capacity utilization management system for shipping and delivery vehicles, the system comprising: a customer database containing identification of a plurality of customers and associated geo-coded location information; a processor coupled to a memory containing instructions providing: a dispatching module to dispatch a vehicle to one or more customer stops for picking up items along a planned route and determining a current location of the vehicle; a capacity module for determining a capacity of the vehicle to carry items to a transit location and determining one or more shipping discounts available to customers based upon the determined capacity of the vehicle and location of the vehicle; a notification module for sending notifications of the determined shipping discount to customers retrieved from the customer database and receiving confirmation from one or more customer of acceptance of the discount; wherein the dispatching module dynamically modifies the planned route based upon location information of the customer acceptance and provides a notification to the vehicle.

This present disclosure provides vehicle capacity utilization by providing real-time discounts to increase delivery and pickup density and improve vehicle utilization. The system and method encourages the growth of density by providing discounts to customers to ship with a transport or company if the driver is already picking up or delivering in a specific area by providing automation of notification of potential customer and the enabling dynamic pricing and rerouting to be performed to optimize efficiency.

The technology uses a mobile device based application or shipping system to signal to customers real-time on discounts based on real-time courier activities. The described technology looks at capacity in a trailer (unused space in a vehicle) and dispatched pickups or pre-planned deliveries to offer discounts to potential customers on these two factors.

This solution offers customer alerts through a mobile device, such as a smartphone, or shipping system to offer real-time shipping discounts. The highest discount is a highly available vehicle that is close to a potential customer. In the transportation business companies try to build density. Density is referred to as the amount of pickups/deliveries in a particular area, the more pickups/deliveries in an area, the more dense it is. Companies strive for density to improve margins on a stop/route by minimizing travel time, employee resources and vehicle expenses.

The more dense a route is the more profitable it becomes as a driver is doing more work (receiving revenue) with reduced effort (less travel time more pickups and deliveries). To drive density the disclosed system gives discounts based on the amount of work being reduced for a driver (proximity to a pre-existing stop, which is a pickup or delivery).

Referring to FIG. 1, a capacity utilization management system 100 tracks the movement of the truck 102 to determine routing information and generate additional pickups by providing discount information to potential customers for shipping of items such as packages or pallets. Dispatch 104 knows the next stops/pickups for the truck 102 in question based upon arranged customer pickups and can define routing information for the vehicle. The dispatch 104 sends out electronic notifications to customers/potential customers on a computing device 110, 112, such as a smartphone, having a processor and memory, or shipping system 112 such as a desktop or mobile computer. In an embodiment the dispatch system or capacity utilization management system 104 alerts customers 110, 112, 114 in the area where a vehicle 102 is picking or delivering where capacity is available for picking up items. The alert can be provided by text, e-mail or in-application notifications to a mobile device 110, 114 or computing device 112. Depending on the proximity to the vehicle and the next driver stop, the system 104 will send discount information 111a-111c, 113a-113c, 115a-115c to customers enticing them to ship their items such as packages or pallets, with the courier by a certain time to minimize travel time for the driver. The closer in proximity of the potential customer to the driver's stop the greater the discount can be applied to increase efficiency of the driver and vehicle. The discount can be dynamically adjusted to tailor the discount entice potential customers while maintaining a profit margin for the delivery service. The driver can be notified via a device 130, such as for example a smartphone to stop at an identified location for example 115a, or on an in vehicle communications system. Global positioning system (GPS) location data 103 provided by telematics of the truck 102 or driver's mobile device 130 is communicated back to the capacity utilization management system 104.

Based upon the customer 111, 113, 115 and truck 102 location cost benefits to increasing vehicle utilization are provided by notification to customers of proximity of a vehicle increasing efficiency in a particular area. The capacity utilization management system 104 is implemented on a processor 150 of a computing device 104. The processor is coupled to a memory 152 which contains non-transitory instructions for providing functionality of the capacity utilization system. The instructions may be divided into functional components such as a dispatch module 160 which receives customer pickup requests and assigns a driver/truck 102 to pick up or drop off deliveries. The dispatch module 160 can interface is a discount capacity utilization module 162 which either estimates capacity of a vehicle 102, or utilizes sensors data from the vehicle or driver to determine possible capacity in the vehicle 102. The notification module 164 can then utilize customer database 166 to determine customer locations which are within the routing proximity of the vehicle 102 and send alerts of possible discounts using geo-coded location data associated with customers. Acceptance or confirmation of the alerts can then be processed and new routing information can be processed by dispatch module 160 to alert the driver. A network interface 154 enable the capacity utilization management system 104 to communicate via a network, such as the Internet and mobile communication networks.

In the capacity utilization management system if it cost X to do a stop for a customer and the profit is Y, by making that stop and being able to engage another customer the cost per stop is X−2 and the profit is Y+2. With that, the delivery service can give a discount of 1 and still make a profit of Y+1. In addition the capacity utilization management system allows customers to enroll for notifications of alerts when a driver is picking up or delivering in their area to receive a discount. The capacity utilization management system drives density in targeted areas. The discount may be a percentage discount that is applied final shipping costs, a discount applied to a portion of the shipping costs, or may be a discount to shipping costs based upon an expected destination for a particular customer, for example a customer who ships a certain size package to the always to same destination.

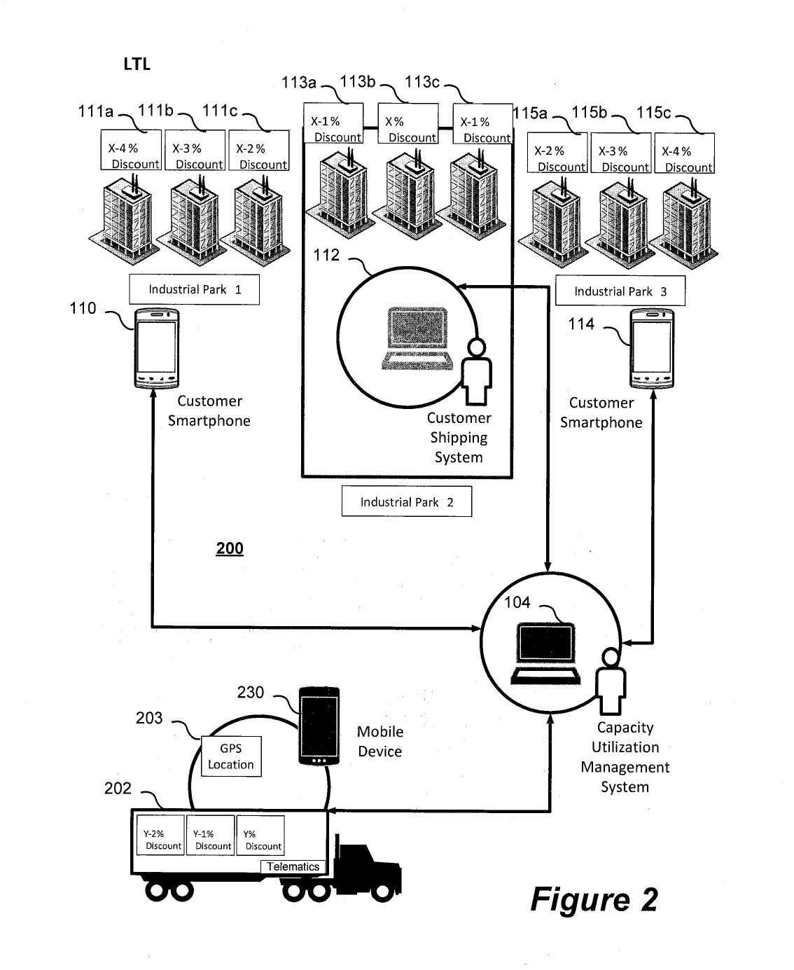

Referring to FIG. 2, shows a capacity driven discounting system 200 which takes into account the amount of space on a truck 202 for both parcel and less-than-truckload (LTL) boxes and pallets. The more space available on the truck 202 the greater the discount. In addition to space, driver proximity, same as the courier model, adds to the discount. The space available may be determined based upon previous pickups by the capacity utilization management system 104 and estimated known pickup points. The volume available may be estimated or utilize volume sensors within the vehicle to determine available space. The interior volume may be determined by volumetric cameras, depth sensors or positions sensor within the vehicle to determine the amount of space that has been utilized. Depending existing space and forecasts the system sends out alerts to customers on their route, or within a defined radius of the route, industrial park, street address range, or building and on their way back to the terminal that they can receive discounts if they ship with an allotted period of time. The system may also utilize routing information to determine customer between two stops, for example between customer A and customer B the travel path may have a potential customer which may not impact driver routing. Time allotment is relative to drivers current location and predicted future location. Drivers update space availability which scrubs against subscription hit rates on capacity request and sends notifications to appropriate amount of customers, for example: driver has 25% capacity available and 25% averages out to 10 customer spots available (based on average piece per shipment and average box size). Typically there is a 50% uptake rate on this route and therefore the capacity utilization system sends notifications to 20 customers and alerts are updated as driver day progresses. Customer alerts are sent in sequence based on customer location relative to driver location relative to the terminal (only sent to customers between driver and the terminal to avoid turning around—this keeps costs in line based on the density discounting model). Deeper discounts are given to customer that can synergize stop locations.

Density discounting provides the ability for customers to sell capacity providing additional discounts for their own shipping. This is driven by geo-coded information that knows who the customers neighbors are through data from the system. The system identifies discounts available to the customer if they can get their neighbors to ship using the delivery system increasing utilization on a drivers route. The system calculates the distance to the neighbors and automatically assigns the discount to the customer and splits between the customer and their neighbor. The revenue split type is configurable by the customer. As the customer preps a shipment the system will alert “if you can get Dave's Shoe Store to ship with service you could qualify for a 30% discount” or “if you can get Dave's Shoe Store to ship with our service you both could qualify for a 15% discount.” Again, the system automatically determines the discount based on customer proximity and the discounting algorithm.

The solutions takes in dispatched information (from dispatching software), coupled with a drivers assigned route and the position information such as global positioning system (GPS) information 203 to advise customers/potential customers of a possible discount if they ship within a defined time period. For example:
If driver A is in industrial park 2 between 2PM and 230PM, other customers within that geographical location would receive a Y % discount if their package is ready by 245PM
In the same scenario above a customer in industrial park 1 or 3 would receive a Y−4% discount (discount is based on the proximity to the pre-existing pickup/delivery)

The LTL system 200 is similar except it also incorporates space in the trailer 202. If a customer is close in proximity to an existing stop and the trailer in question has a lot of capacity, the discount is greater than a trailer that has less capacity. Capacity is determined by the number of pickups done against standard skid sizes. Pallet dimensions can also be used for capacity where a defined number of pallets can fit inside a vehicle.

The described system and method can serve as a great tool for streamlining ad-hoc calls to build margin and increase capacity utilization. For example, a service technician who works in a particular area could solicit customers based on a pre-scheduled call offering discounts. An example would be doing a furnace maintenance. An email would go to the neighbours of the original call and saying “I will be in the area at X time if you want your furnace serviced. Act now and receive a 10% discount.” This could also be used for other static service providers like an auto mechanic offering discounts during periods where the garage isn't busy.

The dispatcher system can comprise a processor and memory for executing instructions for providing the density discount for package delivery. The system may be coupled to one or more wired or wireless networks for receiving and transmitting information from the delivery truck and for communicating with customer systems.

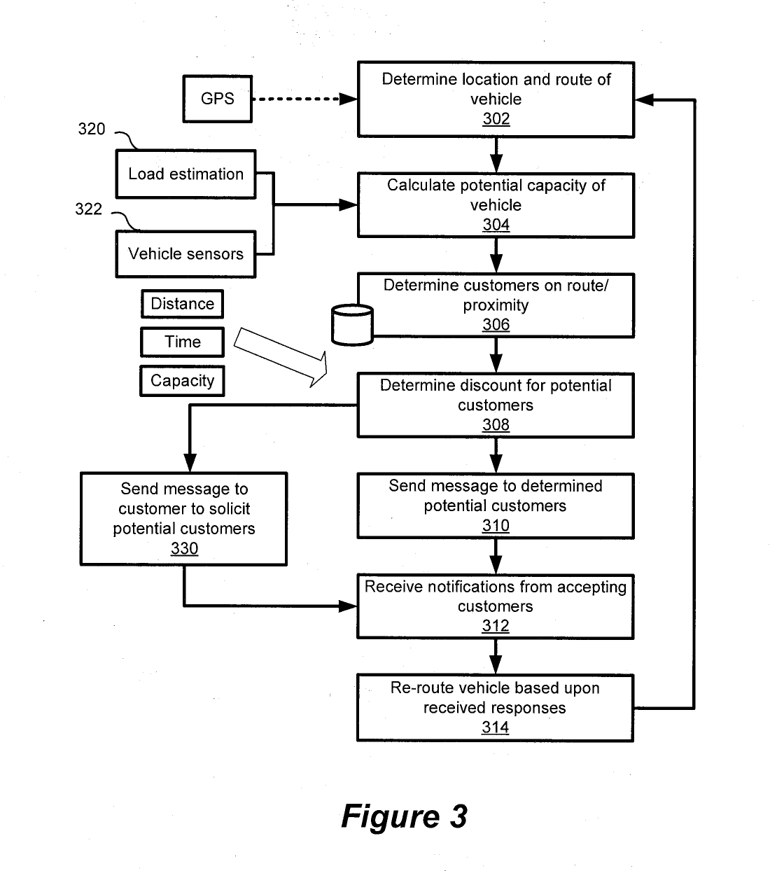

FIG. 3 shows a method vehicle capacity utilization for package delivery. The location of the vehicle is determined (302) from telematics of the vehicle or smartphone position associated with the driver. The capacity of the vehicle is determined (304) by load estimation from pallet or package sizes (320) or vehicle sensors on the interior of the vehicle or by scanning of packages, items or pallets as they are placed in the vehicle by the driver to better estimate size (322). Customers on the route are determine from customer database 166 and their using their location information (306). The determination of the customers may be for potential customers which are notified directly by the system or for customers with scheduled pick or deliver where discounts may be offered if the customer successfully obtains other customer for the system. Discounts for the customers are determined (308) based upon features such as vehicle capacity, customer volume, package size, time, distance and route changes required to accommodate the pickup etc. Messages can then be sent to customers (330) or potential customer (310) advising of discounts available during a specific time period based upon the routing of the vehicle, either to potential customers or existing customers to solicit other customers depending on the system configuration. The message may also define a time period in which the package/items must be available for pickup to receive the discount. The message may be sent by text, e-mail or with an application. Customers must then acknowledge notification (312) which may identify the size or amount of packages. The vehicle can then rerouted (314) or the route dynamically modified to accommodate the new customer pickup. As the route changes additional customer may be contacted with shipping discounts.

Each element in the embodiments of the present disclosure may be implemented as hardware, software/program, or any combination thereof. Software codes, either in its entirety or a part thereof, may be stored in a computer readable medium or memory (e.g., as a ROM, for example a non-volatile memory such as flash memory, CD ROM, DVD ROM, Blu-ray™, a semiconductor ROM, USB, or a magnetic recording medium, for example a hard disk). The program may be in the form of source code, object code, a code intermediate source and object code such as partially compiled form, or in any other form.

It would be appreciated by one of ordinary skill in the art that the system and components shown in FIGS. 1-3 may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

1. A method of delivery vehicle capacity utilization for package delivery, the method comprising:
determining at a capacity utilization management system a location of the vehicle from global positioning data associated with the delivery vehicle;
determining capacity of the vehicle based upon capacity parameters associated with the vehicle, items in the vehicle and expected items to be loaded into the vehicle;
determining one or more customers on a planned route of the vehicle that are within a defined proximity radius of one or more stops along the planned route;
determining shipping cost discounts for the one or more customers based upon the determined capacity of the vehicle;
sending electronic notifications to the possible customers advising of shipping cost discounts available during a time period based upon the planned route of the vehicle;
receiving notification of acceptance from a customer for picking up a shipment by the vehicle; and
modifying the planned route for the vehicle to a customer location associated with the acceptance notification.

2. The method of claim 1 wherein the capacity is determined based upon packages already in the vehicle.

3. The method of claim 1 wherein the capacity is an expected capacity of the vehicle determined based upon dimensions known for packages designated for pickup along the route.

4. The method of claim 1 wherein the electronic notification is sent to possible customers within a designated geographic area of the route based upon customer locations or street routing information.

5. The method of claim 4 wherein the electronic notification specifies a time required for pickup in order to receive shipping costs discounts.

6. The method of claim 1 wherein the shipping costs discount is scaled on volume of the items provided by the customer for shipping.

7. The method of claim 1 wherein the discount is determined based upon a space available on the vehicle.

8. The method of claim 7 wherein the space is determined by weight, volume or weight and volume of the vehicle.

9. The method of claim 1 wherein location of the vehicle is determined by a global positioning system (GPS) location device associated with a vehicle or associated with a mobile device.

10. The method of claim 1 further comprising dynamically contacting additional possible customers as the route of the vehicle is modified or as capacity of the vehicle changes.

11. The method of claim 1 wherein the capacity utilization management system is provided by a server coupled to a network comprising a processor and memory perform method.

12. A capacity utilization management system for shipping and delivery vehicles, the system comprising:
a customer database containing identification of a plurality of customers and associated geo-coded location information;
a processor coupled to a memory containing instructions providing:
a dispatching module to dispatch a vehicle to one or more customer stops for picking up items along a planned route and determining a current location of the vehicle;
a capacity module for determining a capacity of the vehicle to carry items to a transit location and determining one or more shipping discounts available to customers based upon the determined capacity of the vehicle and location of the vehicle;
a notification module for sending electronic notifications of the determined shipping discount to customers retrieved from the customer database and receiving confirmation from one or more customer of acceptance of the discount;
wherein the dispatching module dynamically modifies the planned route based upon location information of the customer acceptance and provides a notification to the vehicle.

13. The system of claim 12 wherein the capacity is determined based upon packages already in the vehicle.

14. The system of claim 12 wherein the notification includes a time period for application of the discount to an item shipment.

15. The system of claim 12 wherein the capacity is an expected capacity of the vehicle determined based upon dimensions known for packages designated for pickup along the route.

16. The system of claim 12 wherein the electronic notifications is sent to possible customers within a designated geographic area of the route based upon customer locations or street routing information.

17. The system of claim 12 wherein the shipping costs discount is scaled on volume of the items provided by the customer for shipping.

18. The system of claim 12 wherein the shipping costs discount is determined based upon a space available on the vehicle.

19. The system of claim 18 wherein the space available is determined by a sensor positioned within the vehicle.

20. The system of claim 12 wherein location of the vehicle is determined by a global positioning system (GPS) location device associated with a vehicle.

21. The system of claim 12 further comprising dynamically contacting additional possible customers as the route of the vehicle is modified or as capacity of the vehicle changes.

22. The system of claim 12 wherein the notification identifies a potential customer for which if the potential customer accepts the discount and existing customer will receive a discount as well.
